(19) United States
(12) Patent Application Publication
(10) Pub. No.: US 2026/0170376 A1
(43) Pub. Date: Jun. 18, 2026

(54) Predictive Profiling Framework for Quantum Environments

(71) Applicant: International Business Machines Corporation, Armonk, NY (US)

(72) Inventors: Francisco Jose MARTIN FERNANDEZ, Ridgefield, CT (US); Ivan DURAN MARTINEZ, Elmsford, NY (US); David KREMER GARCIA, White Plains, NY (US); Juan CRUZ BENITO, Salamanca (ES); Iskandar SITDIKOV, New York, NY (US); David GARCIA VALIÑAS, White Plains, NY (US); Alexandra RIVERO GARCIA, La Orotava (ES); Ismael FARO SERTAGE, CHAPPAQUA, NY (US)

(21) Appl. No.: 19/052,588

(22) Filed: Feb. 13, 2025

(30) Foreign Application Priority Data
Dec. 12, 2024 (EP) 24383357.1

(51) Int. Cl. G06N 10/20; G06N 10/60

(52) U.S. Cl. CPC G06N 10/20; G06N 10/60

(57) ABSTRACT

One or more systems, devices, computer program products and/or computer-implemented methods of use provided herein relate to predictive profiling of quantum environments. The system can comprise a memory that can store computer-executable components. The system can further comprise a processor, operably coupled to the memory, that executes at least one of the computer executable components that can generate a profiling prediction of a quantum environment based on a profiling matrix using a hybrid time series model, wherein the profiling prediction predicts resource consumption of the quantum environment for a portion of an execution in the quantum environment using a hybrid time series model. In various embodiments, the at least one of the computer executable components can further allocate resources between classical components and quantum components of the quantum environment for the portion of the execution based on the profiling prediction.

### BACKGROUND

The subject disclosure relates to profiling quantum environments, and more specifically to predictive profiling of quantum environments.

In quantum computing, profiling refers to analyzing and understanding characteristics of quantum components of a quantum environment to optimize the accuracy and efficiency of calculations. In the quantum environment, there can be a dual-phase workflow, comprising a classical phase and a quantum phase, each requiring different amounts or types of resources. That is, the classical phase can be responsible for preparing an experiment tailored for execution on a quantum computer, and the quantum phase can execute the experiment. To optimize the accuracy and efficiency of dual-phase workflows, accurate assessments of resource requirements are crucial for both the classical phase and the quantum phase.

The above-described background description is merely intended to provide a contextual overview regarding quantum computing and automatic identification of techniques involving quantum computing features and is not intended to be exhaustive.

### SUMMARY

The following presents a summary to provide a basic understanding of one or more embodiments described herein. This summary is not intended to identify key or critical elements, delineate scope of particular embodiments or scope of claims. Its sole purpose is to present concepts in a simplified form as a prelude to the more detailed description that is presented later. In one or more embodiments described herein, systems, computer-implemented methods, apparatus and/or computer program products that enable predictive profiling of quantum environments are discussed.

According to an embodiment, a system is provided. The system can comprise a memory that can store computer executable components. The system can further comprise a processor, operably coupled to the memory, that executes at least one of the computer executable components that can generate a profiling prediction of a quantum environment based on a profiling matrix using a hybrid time series model, wherein the profiling prediction predicts resource consumption of the quantum environment for a portion of an execution in the quantum environment using a hybrid time series model. In various aspects, the at least one of the computer executable components can further allocate resources between classical components and quantum components of the quantum environment for the portion of the execution based on the profiling prediction.

According to an embodiment, a computer-implemented is provided. The computer-implemented can comprise generating, by a system operatively coupled to a processor, a profiling prediction of a quantum environment based on a profiling matrix using a hybrid time series model, wherein the profiling prediction predicts resource consumption of the quantum environment for a portion of an execution in the quantum environment using a hybrid time series model. In various aspects, the computer-implemented can further comprise allocating, by the system, resources between classical components and quantum components of the quantum environment for the portion of the execution based on the profiling prediction.

According to an embodiment, a computer program product for facilitating profiling prediction of quantum environments is provided. The computer program product can comprise a computer readable storage medium having program instructions embodied therewith, the program instructions executable by a processor to cause the processor to generate, by the processor, a profiling prediction of a quantum environment based on a profiling matrix using a hybrid time series model, wherein the profiling prediction predicts resource consumption of the quantum environment for a portion of an execution in the quantum environment using a hybrid time series model. In various aspects, the program instructions executable by the processor can further to cause the processor to allocate, by the processor, resources between classical components and quantum components of the quantum environment for the portion of the execution based on the profiling prediction.

### BRIEF DESCRIPTION OF THE DRAWINGS

One or more embodiments are described below in the Detailed Description section with reference to the following drawings:

FIG. 1 illustrates a block diagram of an example, non-limiting system that can enable predictive profiling of quantum environments in accordance with one or more embodiments described herein.

FIG. 2 illustrates a block diagram of an example, non-limiting quantum system that can at least partially facilitate predictive profiling of quantum environments in accordance with one or more embodiments described herein.

FIG. 3 illustrates a block diagram of an example, non-limiting system that can enable predictive profiling of quantum environments in accordance with one or more embodiments described herein.

FIG. 4 illustrates an example, non-limiting block diagram showing how a profiling matrix can be generated based on execution data in accordance with one or more embodiments described herein.

FIG. 5 illustrates an example, non-limiting block diagram showing how a profiling matrix can be generated based on a profiling prediction in accordance with one or more embodiments described herein.

FIG. 6 illustrates an example, non-limiting block diagram showing how a profiling prediction can be generated based on a profiling matrix in accordance with one or more embodiments described herein.

FIG. 7 illustrates an example, non-limiting profiling matrix in accordance with one or more embodiments described herein.

FIG. 8 illustrates an example, non-limiting profiling matrix in accordance with one or more embodiments described herein.

FIG. 9 illustrates an example, non-limiting diagram showing how profiling matrices can be generated via a hybrid time series forecasting model in accordance with one or more embodiments described herein.

FIG. 10 illustrates an example, non-limiting diagram showing a complete framework that can facilitate predictive profiling of quantum environments in accordance with one or more embodiments described herein.

FIG. 11 illustrates an example, non-limiting diagram showing iterative predictive profiling of quantum environments in accordance with one or more embodiments described herein.

FIG. 12 illustrates a flow diagram of an example, non-limiting method that can facilitate predictive profiling of quantum environments in accordance with one or more embodiments described herein.

FIG. 13 illustrates a flow diagram of an example, non-limiting method that can facilitate predictive profiling of quantum environments in accordance with one or more embodiments described herein.

FIG. 14 illustrates a flow diagram of an example, non-limiting method that can facilitate predictive profiling of quantum environments in accordance with one or more embodiments described herein.

FIG. 15 illustrates a block diagram of an example, non-limiting system including a training component that facilitates predictive profiling of quantum environments in accordance with one or more embodiments described herein.

FIG. 16 illustrates an example, non-limiting block diagram showing how foundation models can be trained in accordance with one or more embodiments described herein.

FIG. 17 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

According to an embodiment, a system is provided. The system can comprise a memory that can store computer executable components. The system can further comprise a processor, operably coupled to the memory, that executes at least one of the computer executable components that can generate a profiling prediction of a quantum environment based on a profiling matrix using a hybrid time series model, wherein the profiling prediction predicts resource consumption of the quantum environment for a portion of an execution in the quantum environment using a hybrid time series model. In various aspects, the at least one of the computer executable components can further allocate resources between classical components and quantum components of the quantum environment for the portion of the execution based on the profiling prediction. Such embodiments of the system can provide a number of advantages, including improving efficiency of resource utilization in a quantum environment and optimizing resource allocation prior to execution of the quantum environment.

In one or more embodiments of the aforementioned system, the at least one of the computer executable components can further generate the profiling matrix based on execution data, wherein the profiling matrix comprises a set of parameters that quantifies resource consumption of the quantum environment. Such embodiments of the system can provide a number of advantages, including improving efficiency of resource utilization in a quantum environment and providing comprehensive overviews of resource consumption.

In one or more embodiments of the aforementioned system, the at least one of the computer executable components can further: generate a time series of the profiling matrix for the execution in the quantum environment; and train the hybrid time series model to generate the profiling prediction based on the time series. Such embodiments of the system can provide a number of advantages, including improving efficiency of resource utilization in a quantum environment.

In one or more embodiments of the aforementioned system, wherein generating the profiling prediction comprises: generating the profiling matrix; creating a configuration of resources of the quantum environment based on the profiling matrix; defining one or more workloads of the execution; and simulating the one or more workloads. Such embodiments of the system can provide a number of advantages, including optimizing resource allocation prior to execution of the quantum environment.

In one or more embodiments of the aforementioned system, the at least one of the computer executable components can further: receive a set of constraints comprising at least one of resource types, simulation length, or overhead constraints; and generate, via the hybrid time series model, the profiling matrix based on the set of constraints. Such embodiments of the system can provide a number of advantages, including improving efficiency of resource utilization in a quantum environment.

In one or more embodiments of the aforementioned system, the at least one of the computer executable components can further: execute a quantum experiment in the quantum environment with an allocation of resources based on the profiling matrix to generate the execution data; and train the hybrid time series model on historical data of the set of parameters, the profiling matrix, and a corresponding ground truth, wherein the corresponding ground truth comprises the execution data. Such embodiments of the system can provide a number of advantages, including enabling continuous training of the hybrid time series model for fine-tuned optimization of resource allocation.

In one or more embodiments of the aforementioned system, wherein generating the time series comprises iteratively generating the profiling matrix throughout the execution in the quantum environment based on the profiling prediction of one or more portions of the execution. Such embodiments of the system can provide a number of advantages, including enabling continuous training of the hybrid time series model for fine-tuned optimization of resource allocation

According to various embodiments, the above-described system can be implemented as a computer-implemented method or as a computer program product.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

In quantum computing, profiling refers to analyzing and understanding characteristics of quantum components (e.g., qubits, quantum operation) of a quantum environment to optimize the accuracy and efficiency of calculations. For example, this can include measuring qubit properties, assessing the quality of quantum operations, optimizing algorithms, and addressing noise and error issues. The quantum environment can be a hybrid computing environment that contains a quantum processing system and a classical processing system. Accordingly, in the quantum environment, there can be a dual-phase workflow, comprising a classical phase and a quantum phase, each requiring different amounts or types of resources. That is, the classical phase can be responsible for preparing an experiment tailored for execution on a quantum computer, and the quantum phase can execute the experiment. To optimize the accuracy and efficiency of dual-phase workflows, accurate assessments of resource requirements (e.g., time, memory consumption, CPU utilization, or other resource consumption metrics) are crucial for both the classical phase and the quantum phase. However, optimizing the dual-phase workflow can necessitate comprehensive profiling or resource estimation of both classical and quantum components as precise estimations for such resources are critical for optimizing the overall workflow's efficiency by ensuring that computational resources are allocated optimally (e.g., preventing potential bottlenecks that can arise during an experiment's execution). An estimation is an approximation or preliminary calculation of a value based on information available at a given moment. In quantum computing, this can refer to a previous execution or other time or resource-related values that can be calculated.

Despite advancements in quantum computing, much of existing techniques are focused on profiling only quantum executions of a workflow, and a gap exists in applying effective profiling and estimation methods within the dual-phase workflow of quantum computing.

Existing techniques generally explain how to determine resource allocations for an entire execution. However, existing techniques cannot offer dynamic allocation of resources for different stages of execution. As such, none of the existing techniques provide a complete framework for profiling and estimating resource consumption within the dual-phase workflow that can capture intricacies of both classical and quantum processing. Thus, a hybrid quantum-classical resource profiling and estimation framework based on current and historical states of the quantum environment can be desirable.

Various embodiments of the present disclosure can be implemented to produce a solution to these problems. Embodiments described herein include systems, computer-implemented methods, and computer program products that can facilitate profiling prediction of quantum environments. For example, based on execution data, a profiling matrix can be generated of a quantum environment. In various embodiments, the profiling matrix can be used as input into time series forecasting model to generate a profiling prediction that predicts resource consumption of the quantum environment. In various aspects, the profiling matrix and profiling prediction can be iteratively generated to predict resource consumption of the quantum environment for any stage of execution. That is, the system can allow iterative profiling prediction in real-time of a quantum environment. Furthermore, based on the profiling prediction, allocations of classical components and quantum components of the quantum environment can be determined according to the profiling prediction. Moreover, after execution of the quantum experiment with dynamic allocation of resources within the dual-stage workflow, corresponding execution data can be utilized as historical data to continuously train the time series forecasting model to predict resource consumption. Thus, the various embodiments herein can determine optimal allocation of resources for quantum experiments prior to executing the quantum experiments, as opposed to executing the quantum experiment and analyzing execution data to obtain profiling data to determine resource allocations.

Various embodiments herein can provide a system that can facilitate predictive profiling to provide improvements to quantum computing in quantum environments. For example, the system can provide efficient utilization of resources for experimental workflows in quantum environments. Further, the system can prevent potential bottlenecks during execution of an experiment. Moreover, various embodiments of the present disclosure can help provide smooth integration of high-performance computing within quantum environments. Further still, various embodiments of the present disclosure can assist researchers and practitioners with making informed decision about resource allocation and overall workflow optimization based on predicted or inferred profiling predictions.

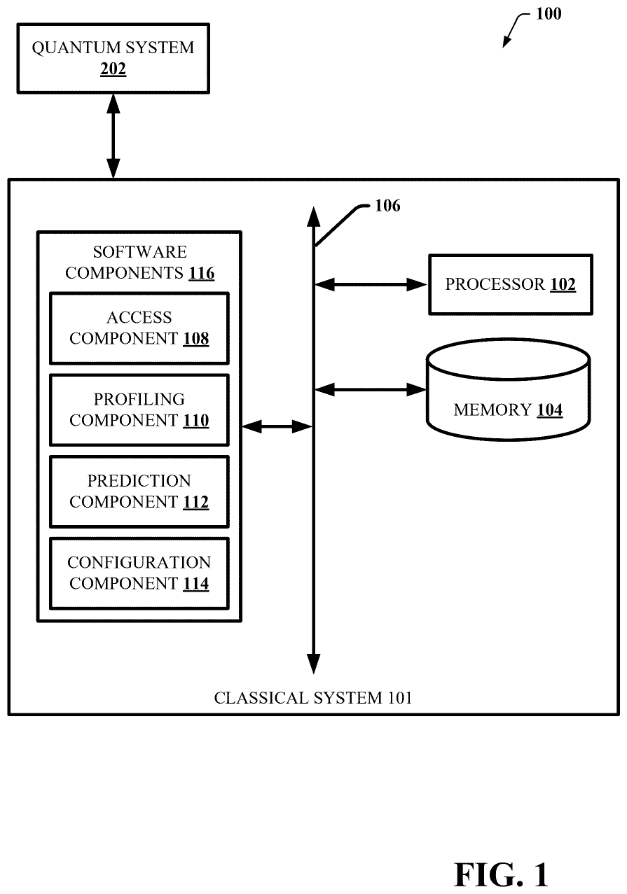

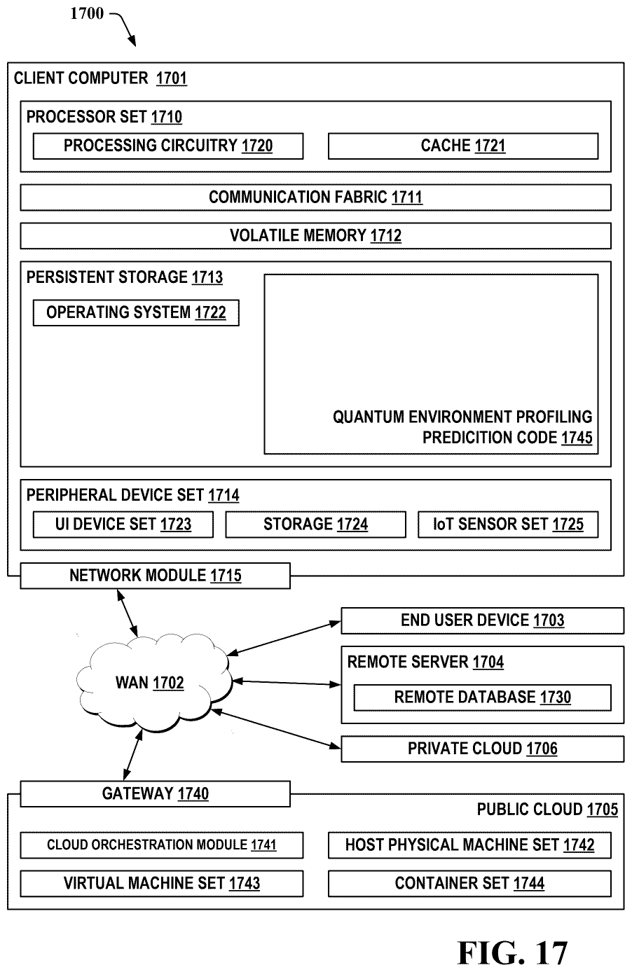

The embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems described herein, such as non-limiting system 100 (e.g., system 100) as illustrated at FIG. 1, and/or systems thereof, can further comprise, be associated with and/or be coupled to one or more computer and/or computing-based elements described herein with reference to an operating environment, such as the operating environment 1700 illustrated at FIG. 17. For example, system 100 can be associated with, such as accessible via, a computing environment 1700 described below with reference to FIG. 17, such that aspects of processing can be distributed between system 100 and the computing environment 1700. In one or more described embodiments, computer and/or computing-based elements can be used in connection with implementing one or more of the systems, devices, components and/or computer-implemented operations shown and/or described in connection with FIG. 1 and/or with other figures described herein.

FIG. 1 illustrates a block diagram of an example, non-limiting system 100 that can enable intelligent and automated recommendations of techniques based on quantum computing to solve problems in accordance with one or more embodiments described herein. Non-limiting system 100 can comprise processor 102, memory 104, software components 116, access component 108, profiling component 110, prediction component 112, and/or configuration component 114.

System 100 and/or the components of system 100 can be employed to use hardware and/or software to solve problems that are highly technical in nature (e.g., related to quantum computing, intelligent profiling predictions of quantum environments, optimized resource allocation, etc.), that are not abstract and that cannot be performed as a set of mental acts by a human. Further, some of the processes performed may be performed by specialized computers for carrying out defined tasks related to optimizing resource allocation in quantum environments. The system 100 and/or components of the system can be employed to solve new problems that arise through advancements in technologies mentioned above, quantum computing, and/or the like. The system 100 can provide technical improvements in terms of optimizing resource allocations between classical and quantum components in quantum environments and improving efficiency of execution by optimizing resource allocations prior to execution, etc.

Discussion turns briefly to processor 102, memory 104 and bus 106 of system 100. For example, in one or more embodiments, the system 100 can comprise processor 102 (e.g., computer processing unit, microprocessor, classical processor, and/or like processor). In one or more embodiments, a component associated with system 100, as described herein with or without reference to the one or more figures of the one or more embodiments, can comprise one or more computer and/or machine readable, writable and/or executable components and/or instructions that can be executed by processor 102 to enable performance of one or more processes defined by such component(s) and/or instruction(s).

In one or more embodiments, system 100 can comprise a computer-readable memory (e.g., memory 104) that can be operably connected to the processor 102. Memory 104 can store computer-executable instructions that, upon execution by processor 102, can cause processor 102 and/or one or more other components of system 100 (e.g., software components 116, access component 108, profiling component 110, prediction component 112, and/or configuration component 114) to perform one or more actions. In one or more embodiments, memory 104 can store computer-executable components (e.g., software components 116, access component 108, profiling component 110, prediction component 112, and/or configuration component 114).

System 100 and/or a component thereof as described herein, can be communicatively, electrically, operatively, optically and/or otherwise coupled to one another via bus 106. Bus 106 can comprise one or more of a memory bus, memory controller, peripheral bus, external bus, local bus, and/or another type of bus that can employ one or more bus architectures. One or more of these examples of bus 106 can be employed. In one or more embodiments, system 100 can be coupled (e.g., communicatively, electrically, operatively, optically and/or like function) to one or more external systems (e.g., a non-illustrated electrical output production system, one or more output targets, an output target controller and/or the like), sources and/or devices (e.g., classical computing devices, communication devices and/or like devices), such as via a network. In one or more embodiments, one or more of the components of system 100 can reside in the cloud, and/or can reside locally in a local computing environment (e.g., at a specified location(s)).

In various embodiments, classical system 101 can be coupled (operatively, communicatively, electrically, and/or like function) to quantum system 202 to perform the operations described by the various embodiments herein. For example, in various embodiments, classical system 101 can be employed to facilitate predictive profiling in a quantum environment.

As described above, in addition to the processor 102 and/or memory 104 described above, system 100 can comprise one or more computer and/or machine readable, writable and/or executable components and/or instructions that, when executed by processor 102, can enable performance of one or more operations defined by such component(s) and/or instruction(s).

In various embodiments, access component 108 can receive execution data in connection with quantum operations in a quantum environment. In various aspects, the execution data can be any suitable electronic data (e.g., one or more scalars, one or more vectors, one or more matrices, one or more tensors, one or more character strings, or any suitable combination thereof).

In various embodiments, profiling component 110 can electronically access the execution data. Based on the execution data, the profiling component 110 can generate a profiling matrix. In various aspects, the profiling matrix can comprise any suitable electronic data (e.g., one or more scalars, one or more vectors, one or more matrices, one or more tensors, one or more character strings, or any suitable combination thereof). For example, the profiling matrix can comprise any suitable electronic data from the execution data. In some instances, the profiling matrix can comprise any suitable format that represents or otherwise coveys the execution data.

In various embodiments, prediction component 112 can employ a hybrid time series forecasting model to automatically generate, based on an input, a profiling prediction of the quantum execution in the quantum environment. In various aspects, the profiling prediction can be any suitable electronic data (e.g., one or more scalars, one or more vectors, one or more matrices, one or more tensors, one or more character strings, or any suitable combination thereof). In various embodiments, the input can comprise the profiling matrix. For example, the hybrid time series forecasting model can receive as input a profiling matrix generated based on an execution of a quantum program or algorithm. As a result, the hybrid time series forecasting model can produce as output a profiling prediction for the execution in the quantum environment.

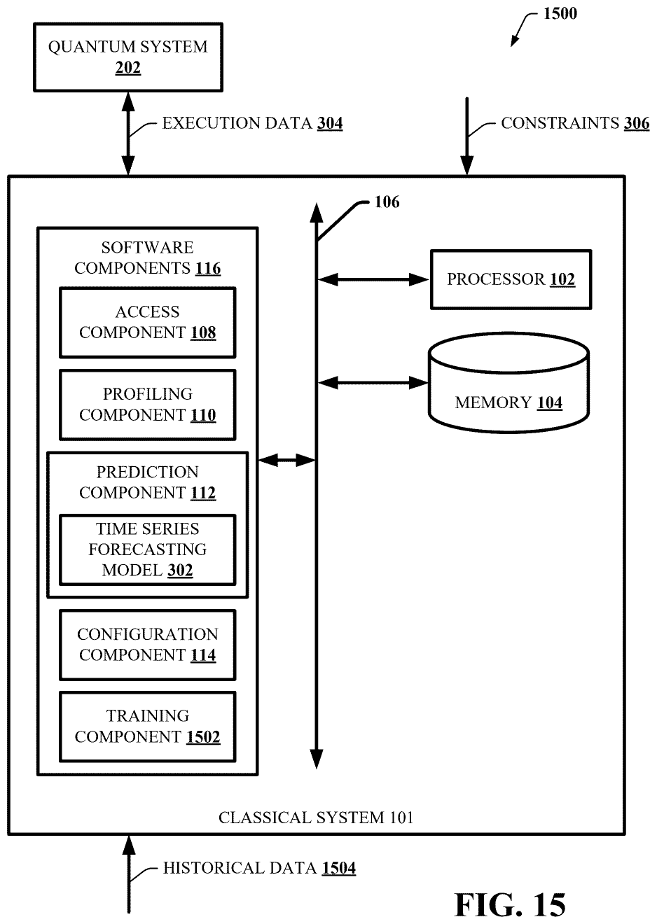

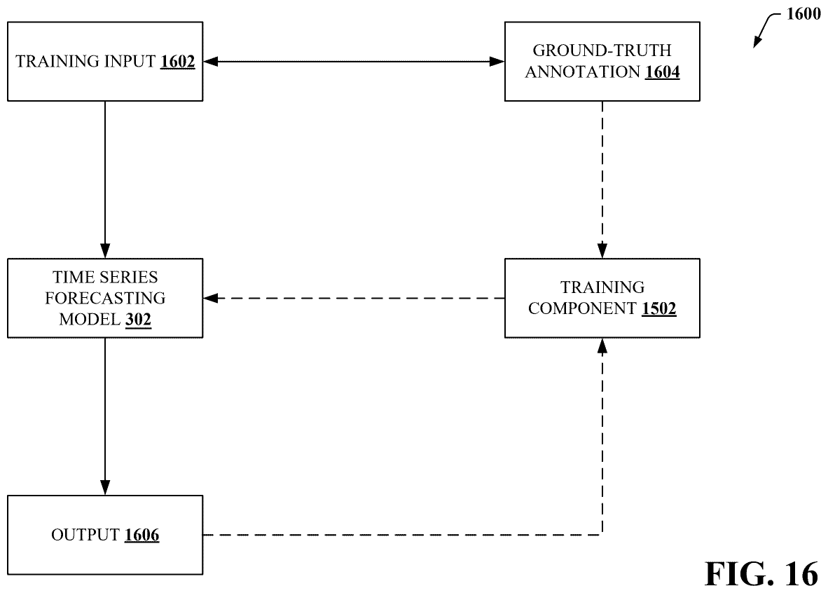

The hybrid time series forecasting model can be trained by training component 1502 as explained infra with reference to FIGS. 15 and 16.

In various embodiments, configuration component 114 can generate, based on the profiling prediction, a reconfiguration of resources of the quantum environment that optimizes resource allocation. In various aspects, the optimized allocation of resources can include allocation (e.g., reconfiguration) of classical resources and quantum resources of the quantum environment. For instance, in a dual-phase workflow, the optimized allocation of resources can define an allocation of classical resources during a classical pre-processing phase of a quantum execution and an allocation of quantum resources during the quantum execution in the quantum phase. As a non-limiting example, the reconfiguration can include reconfigurations to resource allocation or execution paths. In various embodiments, configuration component 114 can execute the reconfiguration or allocation of resources. For example, configuration component 114 can prepare the quantum environment prior to execution by scheduling the resources according to the optimized reconfigurations.

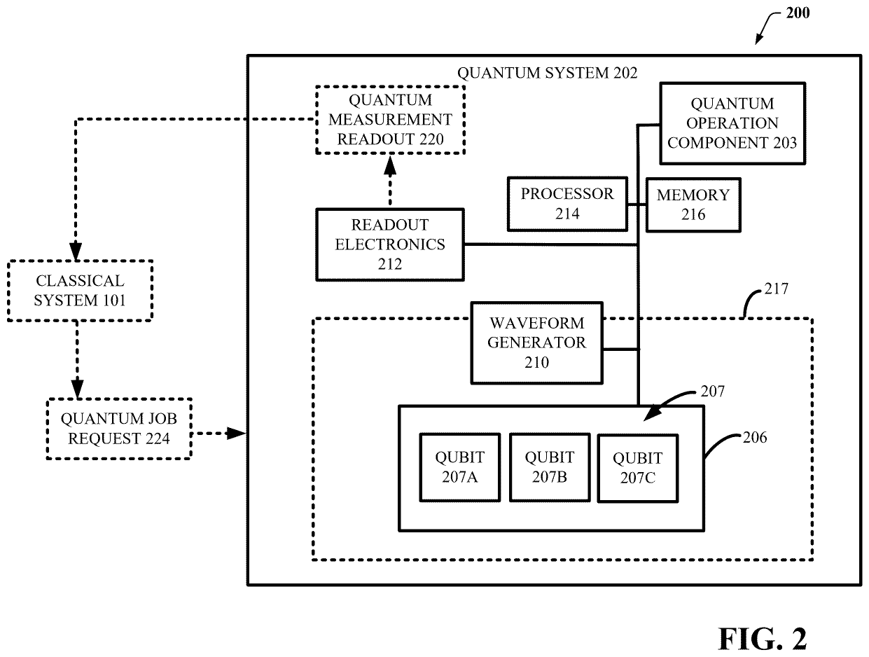

Turning to FIG. 2, one or more embodiments described herein can include one or more devices, systems and/or apparatuses that can provide a process to facilitate predictive profiling of quantum environments. Accordingly, at FIG. 2, illustrated is a block diagram of an example, non-limiting system 200 that can at least partially facilitate such a process. While referring here to one or more processes, facilitations and/or uses of the non-limiting system 200, description provided herein, both above and below, also can be relevant to one or more other non-limiting systems described herein, such as the non-limiting systems 100, 300, or 1500.

As illustrated at FIG. 2, the non-limiting system 200 can comprise a quantum system 202 that can be employed with or separate from the classical system 101.

Generally, the quantum system 202 (e.g., quantum computer system, superconducting quantum computer system and/or the like) can employ quantum algorithms and/or quantum circuitry, including computing components and/or devices, to perform quantum operations and/or functions on input data to produce results that can be output to an entity. The quantum circuitry can comprise quantum bits (qubits), such as multi-bit qubits, physical circuit level components, high level components and/or functions. The quantum circuity can comprise physical pulses that can be structured (e.g., arranged and/or designed) to perform desired quantum functions and/or computations on data (e.g., input data and/or intermediate data derived from input data) to produce one or more quantum results as an output. The quantum results, e.g., quantum measurement readout 220, can be responsive to the quantum job request 224 and associated input data and can be based at least in part on the input data, quantum functions and/or quantum computations.

In one or more embodiments, the quantum system 202 can comprise components, such as a quantum operation component 203, a quantum processor 206, pulse component 410 (e.g., a waveform generator) and/or a readout electronics 212 (e.g., readout component). In one or more other embodiments, the readout electronics 212 can be comprised at least partially by the classical system 101 and/or be external to the quantum system 202. The quantum processor 206 can comprise one or more, such as plural, qubits 207. Individual qubits 207A, 207B and 207C, for example, can be fixed frequency and/or single junction qubits, such as transmon qubits.

In one or more embodiments, a memory 216 and/or processor 214 can be associated with the quantum operation component 203, where suitable. The processor 214 can be any suitable processor. The processor 214 can generate one or more instructions for controlling the one or more processes of the quantum operation component 203.

The quantum operation component 203 can obtain (e.g., download, receive, search for and/or the like) a quantum job request 224 requesting execution of one or more quantum programs and/or a physical qubit layout. The quantum job request 224 can be provided in any suitable format, such as a text format, binary format and/or another suitable format. In one or more embodiments, the quantum job request 224 can be obtained by a component other than of the quantum system 202, such as a by a component of the classical system 101.

The quantum operation component 203 can determine mapping of one or more quantum logic circuits for executing a quantum program. In one or more embodiments, the quantum operation component 203 and/or quantum processor 206 can direct the waveform generator 210 to generate one or more pulses, tones, waveforms and/or the like to affect one or more qubits 207, such as in response to a quantum job request 224.

The waveform generator 210 can generally cause the quantum processor 206 to perform one or more quantum processes, calculations and/or measurements by creating a suitable electro-magnetic signal. For example, the waveform generator 210 can operate one or more qubit effectors, such as qubit oscillators, harmonic oscillators, pulse generators and/or the like to cause one or more pulses to stimulate and/or manipulate the state(s) of the one or more qubits 207 comprised by the quantum system 202.

The quantum processor 206 and a portion or all of the waveform generator 210 can be contained in a cryogenic environment, such as generated by a cryogenic environment 217, such as effected by a dilution refrigerator. Indeed, a signal can be generated by the waveform generator 210 to affect one or more of the plurality of qubits 207. Where the plurality of qubits 207 are superconducting qubits, cryogenic temperatures, such as about 4K or lower, can be employed for function of these physical qubits. Accordingly, one or more elements of the readout electronics 212 also can be constructed to perform at such cryogenic temperatures.

The readout electronics 212, or at least a portion thereof, can be contained in the cryogenic environment 217, such as for reading a state, frequency and/or other characteristic of qubit, excited, decaying or otherwise.

It is noted that the aforementioned description(s) refer(s) to the operation of a single set of instructions run on a single qubit. However, scaling can be achieved. For example, instructions can be calculated, transmitted, employed and/or otherwise used relative to one or more qubits (e.g., non-neighbor qubits) in parallel with one another, one or more quantum circuits in parallel with one another, and/or one or more qubit mappings in parallel with one another.

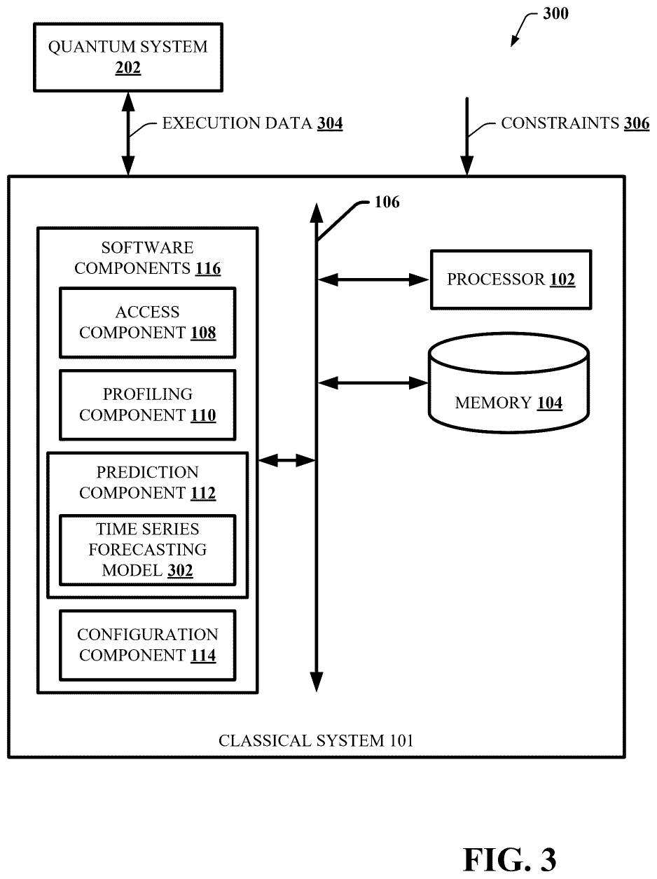

FIG. 3 illustrates a block diagram of an example, non-limiting system 300 that can enable predictive profiling of quantum environments in accordance with one or more embodiments described herein. As shown, the system 300 can, in some cases, comprise the same components as the system 100, and can further comprise a time series forecasting model 302, execution data 304, and set of constraints 306.

In various embodiments, access component 108 can receive execution data 304 from quantum system 202. The execution data 304 can be in connection with quantum operations in a quantum environment. The quantum operations in the quantum environment can be considered as an execution in the quantum environment. In various cases, the execution can comprise one or more phases. For example, the execution in the quantum environment can comprise a classical phase and a quantum phase (e.g., a dual-phase workflow). As another example, the execution can comprise multiple classical phases or multiple quantum phases. In any case, the execution data 304 can be in connection with the execution in the quantum environment. For instance, the execution data 304 can be in connection with execution of a quantum algorithm or program. In other instances, the execution data 304 can be in connection with execution of a quantum circuit.

In various aspects, the execution data 304 can be any suitable electronic data (e.g., one or more scalars, one or more vectors, one or more matrices, one or more tensors, one or more character strings, or any suitable combination thereof). In various embodiments the execution data 304 can be any suitable data that describes or characterizes the quantum environment. In various instances, the execution data 304 can correspond to a partial execution of quantum operations in the quantum environment. That is, the execution data 304 can characterize or quantify resource usage or performance metrics observed up to a particular time. For example, if the execution is in the classical pre-processing phase before actual quantum execution, the access component 108 can receive execution data 304 that quantifies initial resource allocation in the quantum environment. In other instances, the execution data 304 can characterize or quantify initial resource allocation prior to beginning execution in the quantum environment (e.g., estimating required resources and performance metrics based on known characteristics of an algorithm, utilizing historical data from similar executions). Therefore, in various embodiments described herein, prediction component 112 can generate a profiling prediction of the quantum environment to determine an optimal allocation of resources prior to the execution or a remainder of the execution. Such embodiments can provide a number of advantages, including enabling an iterative process that can facilitate dynamic resource allocation throughout execution in the quantum environment to optimize resource allocation.

As a non-limiting example, the execution data 304 can include gate sequences of quantum operations. As another non-limiting example, the execution data 304 can include error rates or error correction data. As yet another non-limiting example, the execution data 304 can include resource utilization metrics of classical components (e.g., CPU utilization, memory usage, disk input/output, energy consumption, cache usage, thread count). As still another non-limiting example, the execution data 304 can include resource utilization metrics of quantum components (e.g., number of qubits, gate count, gate depth, circuit width, quantum memory usage, QPU utilization, coherence time). As even another non-limiting example, the execution data 304 can include execution times of classical or quantum components. As yet another non-limiting example, the execution data 304 can include optimization parameters or results from algorithms. As still another non-limiting example, the execution data 304 can include data transfer rates between classical and quantum processors. In any case, the execution data 304 can describe or characterize the quantum environment in connection with quantum operations.

In various aspects, the access component 108 can electronically access the execution data 304. As a non-limiting example, the access component 108 can electronically retrieve or otherwise electronically obtain the execution data 304 from quantum system 202. In any case, the access component 108 can electronically access the execution data 304, such that the access component 108 can serve as a conduit through which other components of the classical system 101 can electronically interact with the execution data 304.

In various embodiments, profiling component 110 can electronically access the execution data 304. In various instances, the profiling component 110 can generate, based on the execution data 304, a profiling matrix that quantifies resource consumption of the quantum environment (e.g., CPU utilization, QPU utilization, memory usage, network activity).

In various aspects, prediction component 112 can electronically store, electronically maintain, electronically control, or otherwise electronically access the time series forecasting model 302. In various embodiments, the time series forecasting model 302 can generate a profiling prediction of the quantum environment. For example, in an embodiment, the time series forecasting model 302 can generate a profiling prediction that specifies an allocation of resources of the quantum environment that can be required at a particular time during execution. In other words, the time series forecasting model 302 can predict future resource requirements or performance characteristics of the quantum environment. Thus, configuration component 114 can enable dynamic optimization of resource allocation for subsequent quantum or classical execution phases by reconfiguring the resources according to the profiling prediction. For example, configuration component 114 can configure classical hardware components, configure quantum hardware components, or modify execution paths, and so on, according to the profiling prediction. Thus, in various embodiments, configuration component 114 can configure respective quantum systems (e.g., quantum system 202) according to the profiling prediction generated by the time series forecasting model 302, to execute quantum operations in the quantum environment with optimized resource allocation.

In various embodiments, the time series forecasting model 302 can be a hybrid time series forecasting model. A hybrid time series forecasting model is a mode that combines multiple forecasting techniques (e.g., classical statistic methos, machine learning algorithms) to enhance overall accuracy and/or robustness in prediction. In various aspects, the time series forecasting model 302 can have or otherwise exhibit any suitable time series forecasting internal architecture or structure. For instance, the time series forecasting model 302 can include an input stage, one or more processing stages, and an output stage. In various instances, any of these stages can be coupled together by any suitable connections or dependencies, such as autoregressive connections, seasonal components, or trend components. Furthermore, in various cases, any of these stages can incorporate any suitable types of time series forecasting techniques with any suitable configurable or adjustable parameters. For example, any of the input stage, one or more processing stages, or output stage can be Autoregressive Integrated Moving Average (ARIMA) components, whose parameters can include autoregressive coefficients, differencing orders, and moving average coefficients. As another example, any of these stages can be exponential smoothing components, whose parameters can be smoothing factors for level, trend, and seasonality. As still another example, any of these stages can be state space models, whose parameters can include state transition matrices and observation matrices. Further still, in various cases, any of these stages can include any suitable fixed or non-adjustable components. For example, any of the input stages, one or more processing stages, or output stage can include trend removal components, seasonality adjustment components, or residual analysis components.

Regardless of the specific internal architecture (e.g., the specific number, types, or organization of components) implemented within the time series forecasting model 302, the time series forecasting model 302 can be configured for generating profiling predictions of a quantum environment. In other words, the time series forecasting model 302 can be configured to receive a profiling matrix (which can be accompanied by any suitable numerical or graphical data) as input and to generate a profiling prediction, where such profiling prediction represents future resource allocations of the quantum environment.

In various embodiments, a user can specify a set of constraints 306. In various aspects, the access component 108 can electronically access the set of constraints 306. In various embodiments, the time series forecasting model 302 can be further configured to receive the set of constraints 306 with the profiling matrix as input and to generate a profiling prediction that adheres to set of constraints 306. As a non-limiting example, the set of constraints 306 can comprise constraints on resource types in the quantum environment (e.g., the number of qubits available, qubit coherence times, error rates, memory usage, processing time). As another non-limiting example, the set of constraints 306 can comprise constraints on simulation length in the quantum environment (e.g., maximum simulation duration, time states for quantum state evolution, intervals for measuring system properties, convergence criteria for iterative simulations). As still another non-limiting example, the set of constraints 306 can comprise constraints on overhead (e.g., communication latency, synchronization delays, computational overhead from error correction protocols, initialization times for quantum states, calibration intervals for quantum or classical hardware components). In any case, the time series forecasting model 302 can receive the set of constraints 306 to generate a profiling prediction of the quantum environment that adheres to set of constraints 306. However, if no constraints are specified by the user or received by access component 108, system 100 can determine a profiling prediction that optimizes the quantum environment under no constraints. In various instances, the profiling component 110 can also receive the set of constraints 306 to generate a profiling matrix that follows the set of constraints 306. Accordingly, the time series forecasting model 302 can receive the profiling matrix that follows the set of constraints 306 as input. As an example, a user can additionally or optionally input constraints 306 via any suitable user interface to a system (e.g., system 100).

In order for the classical system 101 to function accurately, correctly, or reliably, the time series forecasting model 302 can first undergo training, as described with respect to FIGS. 15 and 16.

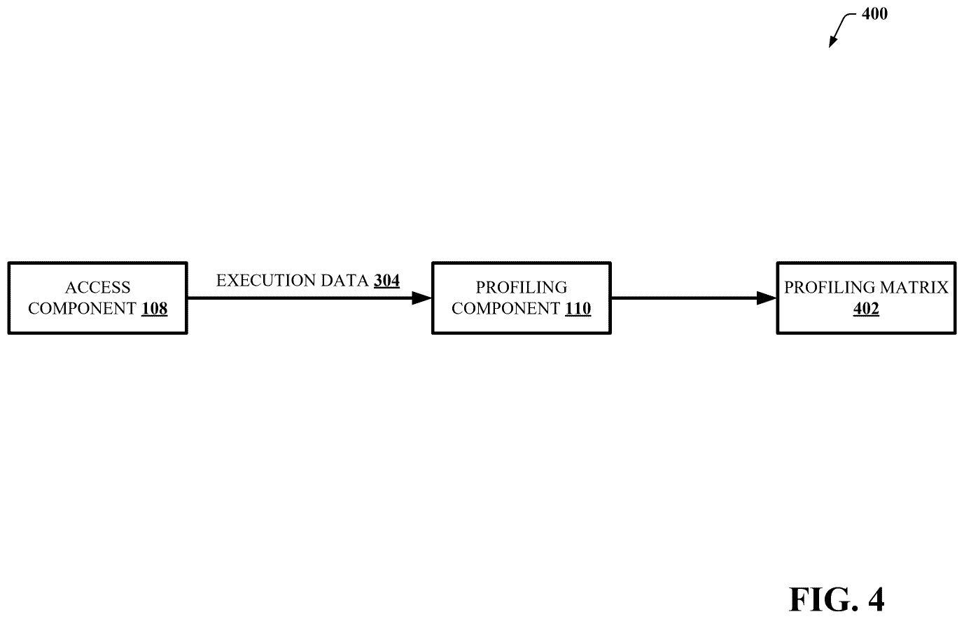

FIG. 4 illustrates an example, non-limiting block diagram showing how a profiling matrix can be generated based on execution data in accordance with one or more embodiments described herein. Repetitive description of like elements and/or processes employed in respective embodiments is omitted for sake of brevity.

In various embodiments, the profiling component 110 can receive execution data 304 from access component 108. The access component 108 can receive or retrieve execution data 304 from a quantum environment (e.g., quantum system 202). As a non-limiting example, the execution data 304 can include resource usage, execution time, or performance metrics. In any case, the profiling component 110 can receive execution data 304 to generate a profiling matrix 402 based on the execution data 304.

In various aspects, the profiling matrix 402 can be in any suitable electronic format (e.g., one or more scalars, vectors, matrices, tensors, character strings, or any suitable combination thereof). That is, the profiling matrix 402 can comprise any suitable electronic format that is a structured representation of the execution data 304. In various cases, the profiling matrix 402 can comprise a set of parameters. Specifically, the profiling matrix 402 can comprise data for the set of parameters. The profiling matrix 402 can comprise any suitable number of parameters that can characterize the quantum environment. Specifically, profiling matrix 402 can comprise any suitable number of parameters that quantify resource consumption of the quantum environment.

In various embodiments, the profiling component 110 can employ any suitable methods to organize execution data 304 into a structured format in profiling matrix 402. As a non-limiting example, the profiling component 110 can normalize or scale the execution data 304 to provide consistency across different metrics or executions. Scaling may also be applied to facilitate comparisons or computations. As another non-limiting example, the profiling component 110 can utilize feature extraction to extract relevant features from execution data 304. In various aspects, any features that can characterize performance, efficiency, or resource utilization of the quantum environment can be considered as relevant features. For example, the profiling component 110 can extract features including average error rate, execution time, energy consumption, or number of gate operations performed from execution data 304.

In various instances, the profiling component 110 can also receive the set of constraints 306 with execution data 304 to generate profiling matrix 402. For example, the set of parameters comprised by profiling matrix 402 can be determined based on the set of constraints 306.

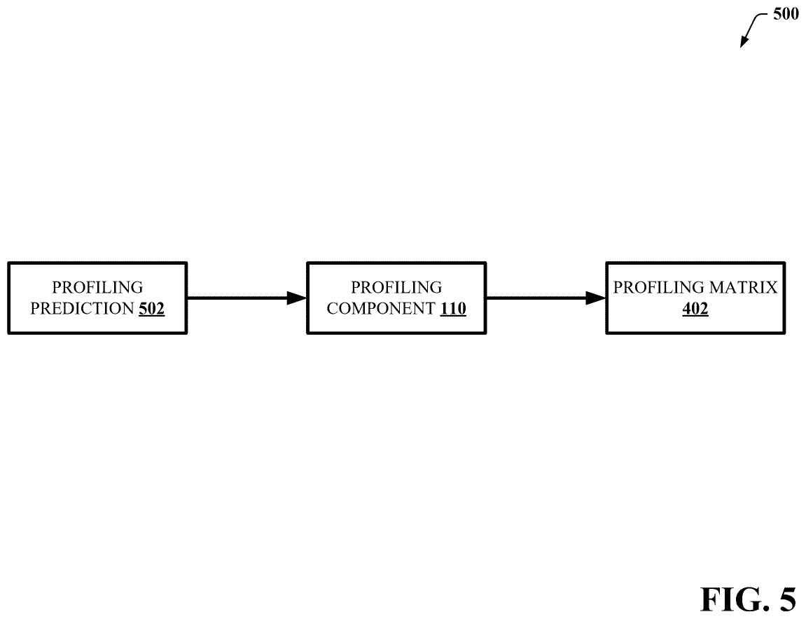

FIG. 5 illustrates an example, non-limiting block diagram 500 showing how a profiling matrix can be generated based on a profiling prediction in accordance with one or more embodiments described herein. Repetitive description of like elements and/or processes employed in respective embodiments is omitted for sake of brevity.

In various embodiments, the profiling component 110 can receive a profiling prediction 502 generated by the time series forecasting model 302. More specifically, the profiling component 110 can receive profiling prediction 502 as input and generate profiling matrix 402 as output. That is, the profiling component 110 can iteratively generate profiling matrix 402 throughout execution in the quantum environment in response to receiving profiling prediction 502 to enable iterative determination of optimal resource allocations throughout execution. In various aspects, the profiling prediction 502 can be any suitable electronic data or comprise any suitable electronic format (e.g., one or more scalars, vectors, matrices, tensors, character strings, or any suitable combination thereof).

The profiling component 110 can receive any suitable number of profiling predictions throughout execution in the quantum environment. In various aspects, generating profiling matrix 402 based on profiling prediction 502 throughout the execution can result in a time series of the profiling matrix 402. In other words, profiling component 110 can generate a time series of profiling matrix 402 for different times of an execution in the quantum environment. For example, the first profiling matrix can be generated from observed date comprised by execution data 304 and subsequent profiling matrices can be generated from one or more profiling predictions. As another example, the first set of profiling matrices can be generated from observed date comprised by execution data 304 and subsequent profiling matrices can be generated from one or more profiling predictions. More specifically, a first phase of an algorithm can be executed to receive execution data 304 and generate profiling matrix 402. Then, a second phase of the algorithm can be executed to receive more execution data 304 to generate another profiling matrix 402. In any case, the profiling matrix 402 (e.g., the one or more profiling matrices) generated can form a time series of resource utilization of the quantum environment. Thus, the profiling matrix 402 can be used as time series training data for the time series forecasting model 302 to generate profiling predictions of the quantum environment that quantify future resource utilization.

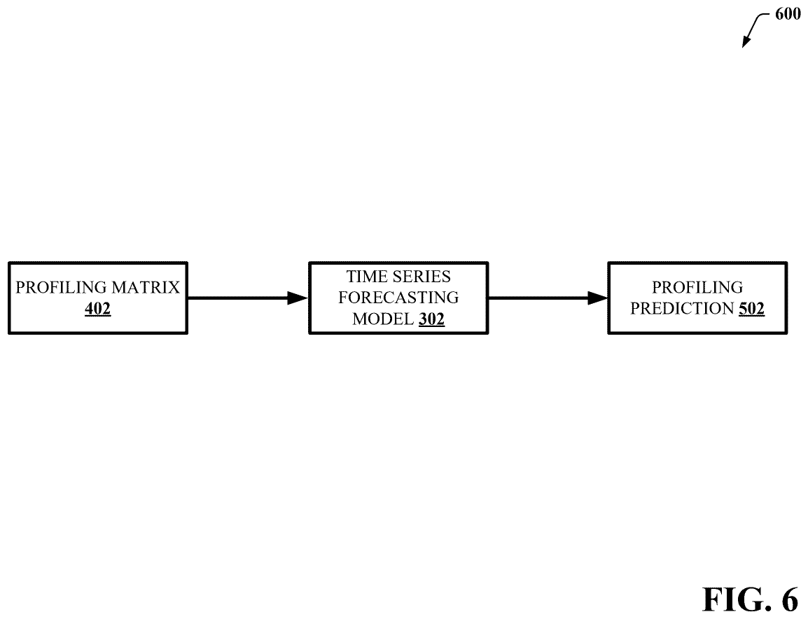

FIG. 6 illustrates an example, non-limiting block diagram 600 showing how a profiling prediction can be generated based on a profiling matrix in accordance with one or more embodiments described herein.

In various embodiments, the time series forecasting model 302 can electronically access the profiling matrix 402. In various aspects, the time series forecasting model 302 can generate, based on the profiling matrix 402 as input, the profiling prediction 502 as output. In various cases, the profiling prediction 502 can predict future resource consumption of the quantum environment. Accordingly, based on the profiling prediction 502, the configuration component 114 can allocate resources between classical and quantum components in the quantum environment. For example, if it is desired to execute a particular algorithm, the access component 108 can receive execution data 304 comprising an initial allocation of resources in the quantum environment. Furthermore, the profiling component 110 can generate, based on the execution data 304, the profiling matrix 402. In some cases, the profiling matrix 402 can quantify resource consumption over a duration of time. In any instance, the time series forecasting model 302 can receive the profiling matrix 402 as input and generate profiling prediction 502 for any future time of execution in the quantum environment. In some instances, the time series forecasting model 302 can generate one or more of profiling prediction 502. The one or more of profiling prediction 502 can define resource consumption at different times in the execution. Non-limiting aspects of training the time series forecasting model 302 are described with respect to FIGS. 15 and 16.

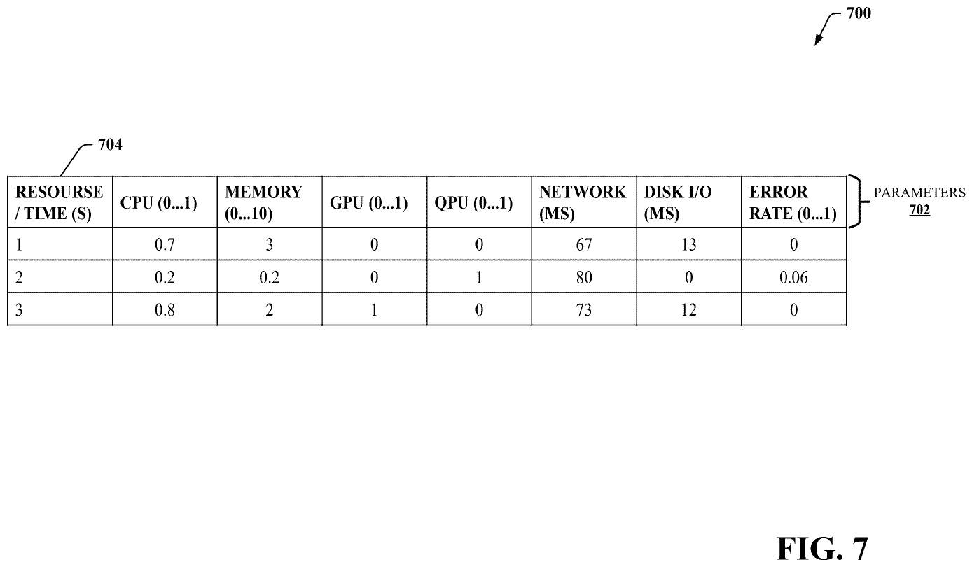

FIG. 7 illustrates an example, non-limiting profiling matrix 700 in accordance with one or more embodiments described herein.

Depicted in FIG. 7 is an example, non-limiting profiling matrix 700 of profiling matrix 402. For example, non-limiting profiling matrix 700 can comprise a set of parameters 702. Specifically, the set of parameters 702 can comprise CPU cycles, memory utilization, GPU cycles, QPU cycles, network activity, disk I/O, or error rates. Although the set of parameters in non-limiting profiling matrix 700 are limited to the set of parameters 702, the set of parameters in any profiling matrix 402 can comprise any suitable parameters that can describe, characterize, or convey resource consumption in the quantum environment. In various cases, the set of parameters 702 can be normalized or scaled to provide consistency in the set of parameters 702. For instance, the network activity and disk I/O can be standardized to be in a same unit of measure (e.g., milliseconds).

In various embodiments, the set of parameters 702 of non-limiting profiling matrix 700 can comprise a time parameter 704. In various aspects, the time parameter 704 can index the set of parameters 702 over a duration of time. That is, the non-limiting profiling matrix 700 can comprise data for the set of parameters 702 over the duration of time. The time parameter 704 can index the set of parameters 702 over any suitable duration of time. For example, the time parameter 704 can index the set of parameters 702 over the entirety of the classical phase of execution. As another example, the time parameter 704 can index the set of parameters 702 over a portion of the classical phase of execution. As yet another example, the time parameter 704 can index the set of parameters 702 over a portion of the classical phase and a portion of the quantum phase of execution. As still another example, the time parameter 704 can index the set of parameters 702 over a portion of the quantum phase of execution. As even another example, the time parameter 704 can index the set of parameters 702 over all phases of execution. As shown in non-limiting profiling matrix 700, the parameter 704 indexes the set of parameters 702 over 3 seconds. In various cases, the time parameter 704 can have any suitable unit of time (e.g., seconds, milliseconds, nanoseconds). In some instances, the set of parameters 702 can have any suitable units of measurement.

In any case, the non-limiting profiling matrix 700 (or any profilin matrix 402) can provide an overview of resource consumption and/or requirements for classical phases or subsequent quantum phases of execution in the quantum environment.

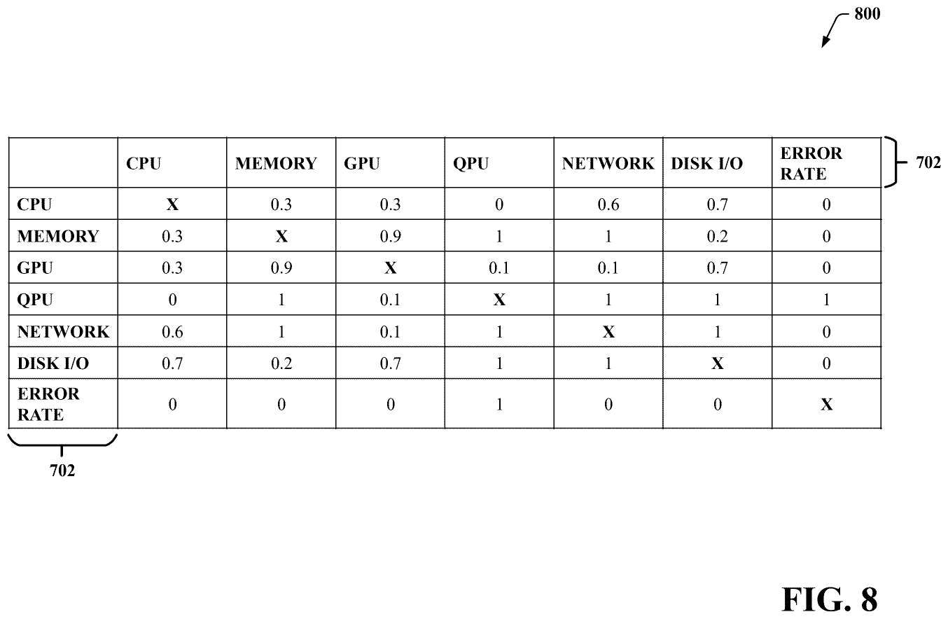

FIG. 8 illustrates an example, non-limiting profiling matrix 800 in accordance with one or more embodiments described herein.

Depicted in FIG. 8 is an example, non-limiting profiling matrix 800 of profiling matrix 402. In various aspects, the non-limiting profiling matrix 800 illustrates an alternative visualization of profiling matrix 402 to show resource consumption and quantum-specific insights of the quantum environment. As shown, the non-limiting profiling matrix 800 can incorporate quantum-specific metrics into profiling methods to provide a comprehensive understanding of resource requirements for quantum computing, particularly in dual-stage workflows.

In various instances, the non-limiting profiling matrix 800 visualizes resource consumption of the quantum environment by illustrating correlations between the set of parameters 702. More specifically, each cell in the non-limiting profiling matrix 800 represents a correlation value between two parameters in the set of parameters 702. Visualizing correlations between the set of parameters 702 as such can assist researchers and practitioners in understanding how different classical and quantum components can affect each other, and thus provide better understanding of how resources can be optimally allocated. For instance, a high correlation between memory utilization and QPU utilization can suggest that increasing memory utilization may also increase QPU utilization.

In various embodiments, the profiling matrix 402 (e.g., non-limiting profiling matrix 700 and 800) can be displayed to a user via any suitable user-computer interface. Therefore, the user can identify key resource relationships or interdependencies to make informed decisions of resource allocation.

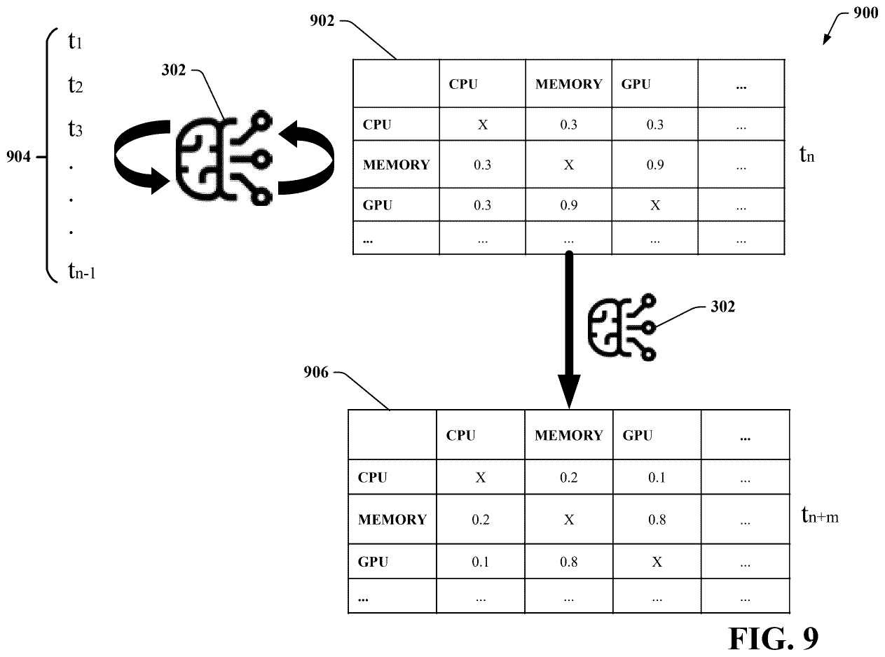

FIG. 9 illustrates an example, non-limiting diagram 900 showing how profiling matrices can be generated via a hybrid time series forecasting model in accordance with one or more embodiments described herein.

In various embodiments, the time series forecasting model 302 can leverage real-time predictive profiling data. Accordingly, configuration component 114 can dynamically allocate resources between classical and quantum components. In various aspects, the time series forecasting model 302 can iteratively generate profiling predictions over a duration of time. More specifically, a duration of time 904 can span from a time t₁ to a time tₙ₋₁ where n can be any positive integer. In various cases, it can be desired to generate a profiling prediction 502 for a particular time during an execution. Such particular time can be denoted by tₙ₊ₘ where m can be any integer such that m≥0. For each time tᵢ in the duration of time 904, the time series forecasting model 302 can generate a profiling prediction. In particular, the time series forecasting model 302 can generate a profiling prediction, and the profiling component 110 can generate a profiling matrix based on each profiling prediction, where each profiling prediction is generated based on the previous profiling matrix. For example, the time series forecasting model 302 can generate a profiling prediction for time t₂. Accordingly, the profiling component 110 can receive the profiling prediction for time t₂ as input and generate a corresponding profiling matrix. Thus, the corresponding profiling matrix to the profiling prediction for time t₂ can be reinput into time series forecasting model 302 to generate a profiling prediction for time t₃. As such, this process can be iterated over the duration of time 904 until time tₙ₋₁. As a result, there can be a profiling matrix 902 corresponding to time tₙ. In various cases, to generate the profiling prediction for time tₙ₊ₘ, the time series forecasting model 302 can receive the profiling matrix 902 corresponding to time tₙ as input, and generate profiling prediction 906.

By generating predictive profiling data, the configuration component 114 can dynamically allocate resources between classical and quantum components for execution in the quantum environment. Such embodiments can provide a number of advantages, including optimizing resource allocation by enabling dynamic allocation of resources for different phases of execution, and thereby minimizing bottlenecks during execution.

In various embodiments, the time series forecasting model 302 can utilize or employ any suitable time series forecasting models to predict the profiling of the quantum environment, such as XGBoost, Random Forest, or Prophet.

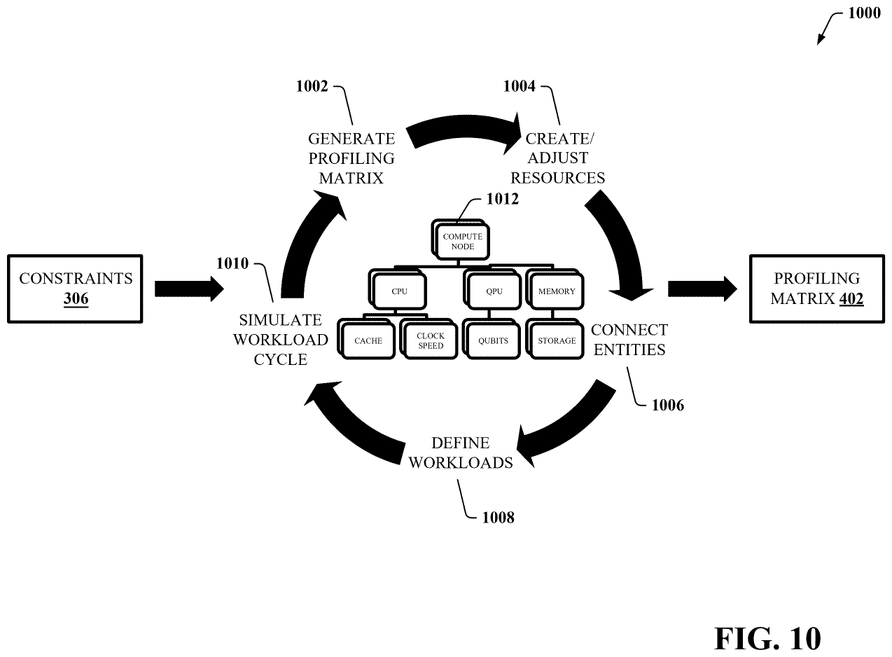

FIG. 10 illustrates an example, non-limiting diagram 1000 showing a framework that can facilitate predictive profiling of quantum environments in accordance with one or more embodiments described herein.

In various embodiments, the framework that can facilitate predictive profiling of quantum environments can comprise multiple stages that can be iterated over. More specifically, the framework can comprise generating a profiling matrix at 1002, creating/adjusting resources at 1004, connecting entities at 1006, defining workloads at 1008, and simulating the workload cycles at 1010.

In various aspects, at any stage, the access component 108 can receive constraints 306. For example, the constraints 306 can comprise constraints on resource types (e.g., CPU, QPU, GPU, memory), simulation lengths, or any other constraints to execute an algorithm in the quantum environment.

In various embodiments, the access component 108 can receive an algorithm or program to execute that comprises a dual-phase workflow. Furthermore, the access component 108 can receive an initial resource allocation for the algorithm or program to execute. Accordingly, the profiling component 110 can generate profiling matrix 402 that corresponds to the algorithm or program to execute, as well as the initial resource allocation and/or constraints 306. Thus, the profiling matrix 402 can be input into the time series forecasting model 302 to generate profiling prediction 502 that corresponds to the profiling matrix 402. In other words, the time series forecasting model 302 can estimate resource consumption the algorithm or program before actual quantum execution in the quantum environment based on the profiling matrix 402.

In various instances, the profiling prediction 502 can be further optimized for execution. In such cases, classical system 101 can iterate over the stages in the framework to obtain an optimal allocation of resources throughout execution. For example, execution can comprise multiple stages that each require different resource allocations. Therefore, the stages can be iterated over to obtain the optimal resource allocations for each stage of execution prior to execution of each stage by leveraging the profiling prediction 502 and profiling matrix 402 in real-time (e.g., during execution).

In various aspects, after generating profiling matrix 402, the configuration component 114 can create or adjust resource configurations based on the profiling matrix 402. Accordingly, the configuration component 114 can connect entities. In various aspects, connecting entities can comprise establishing connections between different classical and quantum components in the quantum environments. For instance, as shown, the configuration component 114 can establish connections between resources 1012. After connecting entities, the configuration component 114 can define workloads. In particular, the configuration component 114 can specify tasks, operations, or stages to be executed in the quantum environment. In various cases, an execution in the quantum environment can comprise one or more workloads (e.g., stages of execution). In any case, the configuration component 114 can simulate the workloads to generate profiling prediction 502. From the profiling prediction 502, the profiling component 110 can generate profiling matrix 402 that corresponds to the profiling prediction 502 from the previous iteration of the framework via the time series forecasting model 302. In various embodiments, such an iterative process can be repeated until a desired result is achieved. Within each iteration, the configuration component 114 can dynamically allocate resources between classical components and quantum components of the quantum environment. In other words, the iterative feedback loop can consist of continuous adjustment to resources and execution based on real-time data and intermediate results. Therefore, resource consumption and performance can be predicted based on profiling matrix 402 and historical data from previous executions.

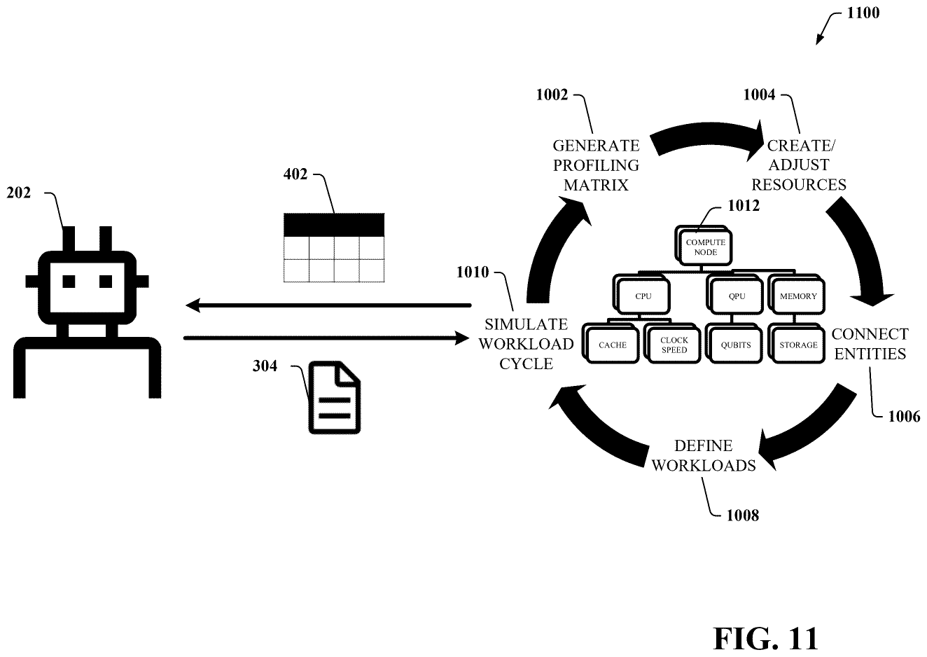

FIG. 11 illustrates an example, non-limiting diagram 1100 showing iterative predictive profiling of quantum environments in accordance with one or more embodiments described herein.

In various embodiments, in response to generating the profiling prediction 502 and the corresponding profiling matrix 402 for a given quantum experiment, the configuration component 114 can allocate resources between classical components and quantum components of the quantum environment according to the profiling matrix 402. Thus, the quantum experiment can be executed under such allocation of resources, which can be considered as optimized for that quantum experiment. In various embodiments, the configuration component 114 can determine such allocation of resources by generating hardware reconfigurations, software reconfigurations, or parameter reconfigurations based on the profiling matrix 402. In any case, the quantum experiment can be executed in the quantum environment with the allocated resources according to the profiling matrix 402. In response to execution of the quantum experiment, execution data 304 can be generated. In various embodiments, the execution data 304 generated from the execution can be utilized to continuously train the time series forecasting model 302. In particular, the execution data 304 can be used with the profiling matrix 402 generated for that execution and historical data as a ground truth and training input pair. In other words, the execution data 304 can be used as ground truth data that corresponds to the profiling matrix 402 and historical data to train the time series forecasting model 302. In various aspects, this can be done to continuously train the time series forecasting model 302 after each execution to refine or fine-tune model performance.

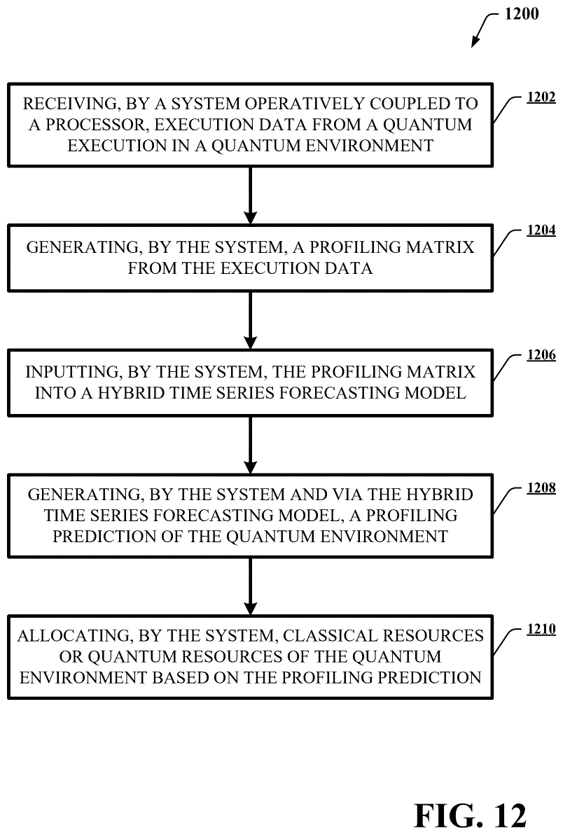

FIG. 12 illustrates a flow diagram of an example, non-limiting method 1200 that can facilitate predictive profiling of quantum environments in accordance with one or more embodiments described herein. One or more operations described with respect to FIG. 12 can be performed by one or more components of system 100 or 300 of FIG. 1 or 3. Repetitive description of like elements and/or processes employed in respective embodiments is omitted for sake of brevity.

At 1202, the non-limiting method 1200 can comprise receiving (e.g., by access component 108), by a system operatively coupled to a processor, execution data (e.g., 304) from a quantum execution in a quantum environment.

At 1204, the non-limiting method 1200 can comprise generating (e.g., by profiling component 110), by the system, a profiling matrix (e.g., 402) from the execution data.

At 1206, the non-limiting method 1200 can comprise inputting (e.g., by prediction component 112), by the system, the profiling matrix into a hybrid time series forecasting model (e.g., 302).

At 1208, the non-limiting method 1200 can comprise generating (e.g., by prediction component 112), by the system and via the hybrid time series forecasting model, a profiling prediction (e.g., 502) of the quantum environment.

At 1210, the non-limiting method 1200 can comprise allocating (e.g., by configuration component 114), by the system, classical resources or quantum resources of the quantum environment based on the profiling prediction.

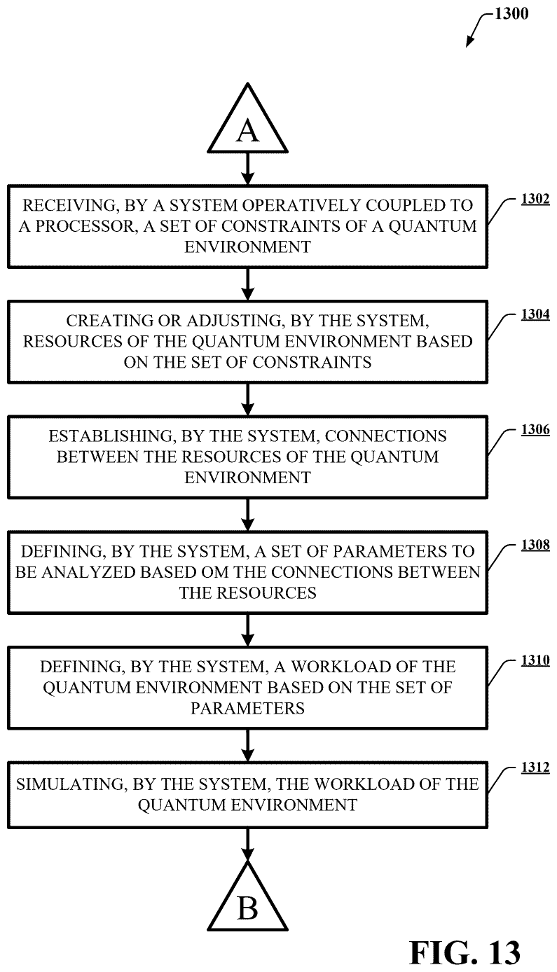

FIG. 13 illustrates a flow diagram of an example, non-limiting method 1300 that can facilitate predictive profiling of quantum environments in accordance with one or more embodiments described herein.

At 1302, the non-limiting method 1300 can comprise receiving (e.g., by access component 108), by a system operatively coupled to a processor, a set of constraints of a quantum environment.

At 1304, the non-limiting method 1300 can comprise creating or adjusting (e.g., by configuration component 114), by the system, resources of the quantum environment based on the set of constraints.

At 1306, the non-limiting method 1300 can comprise establishing (e.g., by profiling component 110), by the system, connections between the resources of the quantum environment.

At 1308, the non-limiting method 1300 can comprise defining (e.g., by profiling component 110), by the system, a set of parameters to be analyzed based om the connections between the resources.

At 1310, the non-limiting method 1300 can comprise defining (e.g., by profiling component 110), by the system, a workload of the quantum environment based on the set of parameters.

At 1312, the non-limiting method 1300 can comprise simulating (e.g., by prediction component 112), by the system, the workload of the quantum environment.

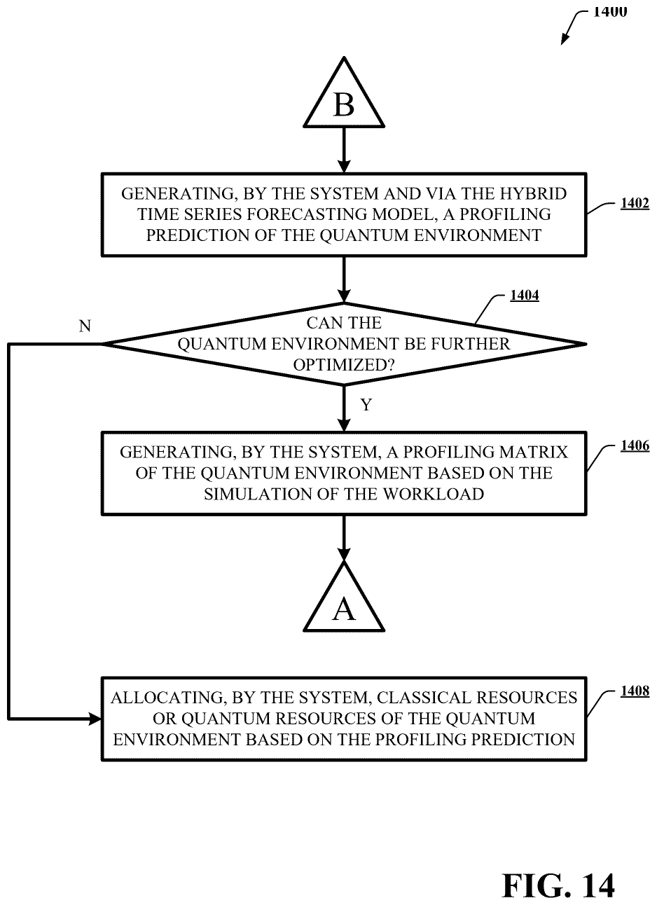

FIG. 14 illustrates a flow diagram of an example, non-limiting method 1400 that can facilitate predictive profiling of quantum environments in accordance with one or more embodiments described herein.

With continued reference to non-limiting method 1300, non-limiting method 1400 can facilitate predictive profiling of quantum environments in accordance with one or more embodiments described herein.

At 1402, the non-limiting method 1400 can comprise receiving (e.g., by access component 108), by a system operatively coupled to a processor, a set of constraints of a quantum environment.

At 1404, the non-limiting method 1400 can comprise determining (e.g., by configuration component 114), by the system, if the quantum environment can be further optimized. If yes (e.g., the quantum environment can be further optimized), the non-limiting method 1400 can proceed to 1406. If no (e.g., the quantum environment cannot be further optimized), the non-limiting method 1400 can proceed to 1408.

At 1406, the non-limiting method 1400 can comprise generating (e.g., by profiling component 110), by the system, a profiling matrix (e.g., 302) of the quantum environment based on the simulation of the workload.

At 1408, the non-limiting method 1400 can comprise allocating (e.g., by configuration component 114), by the system, classical resources or quantum resources of the quantum environment based on the profiling prediction.

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. Additionally, the computer-implemented methodologies described hereinafter and throughout this specification are capable of being stored on an article of manufacture to enable transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

One or more embodiments described herein can employ hardware and/or software to solve problems that are highly technical, that are not abstract, and that cannot be performed as a set of mental acts by a human. For example, a human, or even thousands of humans, cannot efficiently, accurately and/or effectively identify one or more combinations of entities comprising quantum algorithms, quantum hardware units, error mitigation techniques, procedures, parameters, etc. that can be implemented to solve optimization problems, classification problems and so on, as the one or more embodiments described herein can enable this process. And, neither can the human mind nor a human with pen and paper analyze results, generated by execution of the one or more combinations of entities on a quantum computing platform, based on a performance metric, to identify the best combinations of entities in connection with a particular problem, as conducted by one or more embodiments described herein.

Various embodiments discussed herein can provide an intelligent system that can provide improvements to a quantum computing platform. For example, the intelligent system can assist researchers to discover new ways of solving quantum-computing related tasks and to test different combinations of algorithms, parameters, procedures, and hardware to solve problems and find optimal solutions that can improve upon existing solutions. Further, the intelligent system can help practitioners test different solutions and understand how various procedures, hardware units, and algorithms can affect problem solutions and discover new ways of solving quantum-computing related tasks. As such the various embodiments discussed herein can provide a number of advantages, including assisting researchers and practitioners with automating a discovery of solutions to problems (e.g., optimization problems, computational problems, etc.) by automatically identifying combinations of existing quantum algorithms, procedures, configurations, parameters, and quantum hardware units that can be employed for solving the problems, assisting users with benchmarking how feasible different tasks can be, based on an existing set of quantum computing-based resources, and assisting users in selection of error mitigation strategies that can be suitable for a problem provide by the users and a hardware specified by the users.

FIG. 15 illustrates a block diagram of an example, non-limiting system 1500 including a training component and historical data that facilitates predictive profiling of quantum environments in accordance with one or more embodiments described herein. As shown, the system 1500 can, in some cases, comprise the same components as the system 300, and can further comprise a training component 1502 and historical data 1504.

In various instances, the training component 1502 can train the time series forecasting model 302 using any suitable training paradigm. In some cases, such training can be facilitated in supervised fashion, as described with respect to FIG. 16.

In various aspects, the historical data 1504 can comprise any suitable electronic data (e.g., one or more scalars, one or more vectors, one or more matrices, one or more tensors, one or more character strings, or any suitable combination thereof). In various cases, the historical data 1504 can comprise any suitable data from prior executions of the quantum environment, such as performance metrics or resource consumption data from such prior executions.

In various cases, if the time series forecasting model 302 has not yet undergone any training, the training component 1502 can randomly initialize the trainable internal parameters (e.g., convolutional kernels, weight matrices, bias vectors) of the time series forecasting model 302. In contrast, if the time series forecasting model 302 has already undergone at least some training, the training component 1502 can refrain from re-initializing the trainable internal parameters of the time series forecasting model 302.

In various aspects, the training component 1502 can execute the time series forecasting model 302 on the profiling matrix 402 and historical data 1504, thereby causing the time series forecasting model 302 to produce some output. In particular, the training component 1502 can feed the profiling matrix 402 and historical data 1504 to an input layer of the time series forecasting model 302, the profiling matrix 402 and historical data 1504 can complete a forward pass through one or more hidden layers of the time series forecasting model 302, and such forward pass can cause an output layer of the time series forecasting model 302 to compute the output based on activations provided by the one or more hidden layers.

Note that the format, size, or dimensionality of the output can be controlled or otherwise dictated by the number, arrangement, or sizes of the neurons or of other internal parameters (e.g., convolutional kernels) that are contained in or that otherwise make up the output layer of the time series forecasting model 302. So, the output can be forced to have any suitable or any desired format, size, or dimensionality, by adding, removing, or otherwise adjusting neurons or other internal parameters to, from, or within the output layer of the time series forecasting model 302. So, the output can be considered as a profiling prediction that is a predicted or inferred optimized allocation of resources of the quantum environment (e.g., believes is an optimized resource allocation for the quantum environment). In various cases, if the time series forecasting model 302 has so far undergone no or little training, the output can be highly inaccurate (e.g., can be very different from corresponding ground-truth).

In any case, the training component 1502 can compute an error or loss (e.g., mean absolute error (MAE), mean squared error (MSE), cross-entropy error) between the output and the ground-truth profiling predictions. In various aspects, the training component 1502 can update the trainable internal parameters of the time series forecasting model 302 by performing backpropagation (e.g., stochastic gradient descent) driven by the computed error or loss.

In various aspects, such training procedure can be repeated for any suitable number of profiling-matrix-and-profiling-prediction pairs. Such training can ultimately cause the trainable internal parameters of the time series forecasting model 302 to become iteratively optimized for accurately predicting optimized resource allocations of the quantum environment. Note that the training component 1502 can implement any suitable training batch sizes, any suitable training termination criteria, or any suitable error, loss, or objective functions.

FIG. 16 illustrates an example, non-limiting block diagram 1600 showing how the hybrid time series forecasting model can be trained in accordance with one or more embodiments described herein.

In various aspects, prior to beginning training, the training component 1502 can initialize in any suitable fashion (e.g., via random initialization) trainable internal parameters (e.g., convolutional kernels, weight matrices, bias values) of the time series forecasting model 302.

In various embodiments, there can be a training input 1602 and a ground-truth annotation 1604. When it is desired to train the time series forecasting model 302, the training input 1602 can be a training profiling matrix, and the ground-truth annotation 1604 can be correct or accurate generated profiling predictions that is known or deemed to correspond to the training input 1602.

In any case, the training component 1502 can execute the time series forecasting model 302 on the training input 1602, thereby causing the time series forecasting model 302 to produce an output 1606. More specifically, in some cases, the training component 1502 can feed or route the training input 1602 to the input layer of the time series forecasting model 302, the training input 1602 can complete a forward pass through the one or more hidden layers of the time series forecasting model 302, and the output layer of the time series forecasting model 302 can compute the output 1606 based on activation maps or feature maps provided by the one or more hidden layers of the time series forecasting model 302.

Note that the format, size, or dimensionality of the output 1606 can be dictated by the number, arrangement, sizes, or other characteristics of the neurons, convolutional kernels, or other internal parameters of the output layer (or of any other layers) of the time series forecasting model 302. Accordingly, the output 1606 can be forced to have any desired format, size, or dimensionality, by adding, removing, or otherwise adjusting characteristics of the output layer (or of any other layers) of the time series forecasting model 302.

In various aspects, if the output 1606 is produced by the time series forecasting model 302, the output 1606 can be considered as the predicted or inferred optimized resource allocation for the quantum environment that the time series forecasting model 302 has generated based on the training input 1602. In various instances, the ground-truth annotation 1604 can be considered as whatever correct or accurate result (e.g., correct or accurate optimized resource allocation for the quantum environment) that is known or deemed to correspond to the training input 1602. Note that, if the time series forecasting model 302 has so far undergone no or little training, then the output 1606 can be highly inaccurate. In other words, the output 1606 can be very different from the ground-truth annotation 1604.

In various aspects, the training component 1502 can compute an error (e.g., mean absolute error (MAE), mean squared error (MSE), cross-entropy error) between the output 1606 and the ground-truth annotation 1604. In various instances, the training component 1502 can incrementally update the trainable internal parameters of the time series forecasting model 302 (or of the time series forecasting model 302), via backpropagation (e.g., stochastic gradient descent) based on the computed error.

In various cases, such execution-and-update procedure can be repeated for any suitable number input-annotation pairs. This can ultimately cause the trainable internal parameters of the time series forecasting model 302 to become iteratively optimized for accurately generating optimized resource allocations for the quantum environment. In various aspects, the training component 1502 can utilize any suitable training batch sizes, any suitable error/loss functions, or any suitable training termination criteria.

Although the herein disclosure mainly describes the time series forecasting model 302 as being trained in supervised fashion, this is a mere non-limiting example for ease of explanation and illustration. In various embodiments, any other suitable training paradigm can be used to train the time series forecasting model 302 such as unsupervised training or reinforcement learning.

In various embodiments, the time series forecasting model 302 can learn over time from previous executions of the quantum environment and corresponding profiling matrices. The training of the system can comprise using past executions of on classical or quantum hardware (e.g., historical data), comprising pairs of user inputs and corresponding profiling predictions, based for the system to learn to predict or infer a profiling prediction based on a profiling matrix without having to execute the quantum experiment (e.g., algorithm, program). Once trained, the time series forecasting model 302 can predict or infer a profiling prediction based on a profiling matrix for execution in the quantum environment. The training of the time series forecasting model 302 can be performed periodically to keep the time series forecasting model 302 up to date with new data received from recent executions (e.g., executions performed within a specific time interval) on classical or quantum hardware.

FIG. 17 illustrates a block diagram of an example, non-limiting operating environment 1700 in which one or more embodiments described herein can be facilitated. FIG. 17 and the following discussion are intended to provide a general description of a suitable operating environment 1700 in which one or more embodiments described herein at FIGS. 1-16 can be implemented.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1700 contains an example of an environment for the execution of at least some of the computer code involved in performing the inventive methods, such as quantum environment profiling prediction code 1726. In addition to block 1726, computing environment 1700 includes, for example, computer 1701, wide area network (WAN) 1702, end user device (EUD) 1703, remote server 1704, public cloud 1705, and private cloud 1706. In this embodiment, computer 1701 includes processor set 1710 (including processing circuitry 1720 and cache 1721), communication fabric 1711, volatile memory 1712, persistent storage 1713 (including operating system 1722 and block 1726, as identified above), peripheral device set 1714 (including user interface (UI), device set 1725, storage 1724, and Internet of Things (IoT) sensor set 1725), and network module 1715. Remote server 1704 includes remote database 1730. Public cloud 1705 includes gateway 1740, cloud orchestration module 1741, host physical machine set 1742, virtual machine set 1743, and container set 1744.

COMPUTER 1701 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1730. As is well understood in the art of computer technology, and depending upon the technology, performance of a computer-implemented method may be distributed among multiple computers and/or between multiple locations. On the other hand, in this presentation of computing environment 1700, detailed discussion is focused on a single computer, specifically computer 1701, to keep the presentation as simple as possible. Computer 1701 may be located in a cloud, even though it is not shown in a cloud in FIG. 17. On the other hand, computer 1701 is not required to be in a cloud except to any extent as may be affirmatively indicated.

PROCESSOR SET 1710 includes one, or more, computer processors of any type now known or to be developed in the future. Processing circuitry 1720 may be distributed over multiple packages, for example, multiple, coordinated integrated circuit chips. Processing circuitry 1720 may implement multiple processor threads and/or multiple processor cores. Cache 1721 is memory that is located in the processor chip package(s) and is typically used for data or code that should be available for rapid access by the threads or cores running on processor set 1710. Cache memories are typically organized into multiple levels depending upon relative proximity to the processing circuitry. Alternatively, some, or all, of the cache for the processor set may be located “off chip.” In some computing environments, processor set 1710 may be designed for working with qubits and performing quantum computing.

Computer readable program instructions are typically loaded onto computer 1701 to cause a series of operational steps to be performed by processor set 1710 of computer 1701 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1721 and the other storage media discussed below. The program instructions, and associated data, are accessed by processor set 1710 to control and direct performance of the inventive methods. In computing environment 1700, at least some of the instructions for performing the inventive methods may be stored in block 1726 in persistent storage 1713.

COMMUNICATION FABRIC 1711 is the signal conduction paths that allow the various components of computer 1701 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1712 is any type of volatile memory now known or to be developed in the future. Examples include dynamic type random access memory (RAM) or static type RAM. Typically, the volatile memory is characterized by random access, but this is not required unless affirmatively indicated. In computer 1701, the volatile memory 1712 is located in a single package and is internal to computer 1701, but, alternatively or additionally, the volatile memory may be distributed over multiple packages and/or located externally with respect to computer 1701.

PERSISTENT STORAGE 1713 is any form of non-volatile storage for computers that is now known or to be developed in the future. The non-volatility of this storage means that the stored data is maintained regardless of whether power is being supplied to computer 1701 and/or directly to persistent storage 1713. Persistent storage 1713 may be a read only memory (ROM), but typically at least a portion of the persistent storage allows writing of data, deletion of data and re-writing of data. Some familiar forms of persistent storage include magnetic disks and solid state storage devices. Operating system 1722 may take several forms, such as various known proprietary operating systems or open source Portable Operating System Interface type operating systems that employ a kernel. The code included in block 1726 typically includes at least some of the computer code involved in performing the inventive methods.

PERIPHERAL DEVICE SET 1714 includes the set of peripheral devices of computer 1701. Data communication connections between the peripheral devices and the other components of computer 1701 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1725 may include components such as a display screen, speaker, microphone, wearable devices (such as goggles and smart watches), keyboard, mouse, printer, touchpad, game controllers, and haptic devices. Storage 1724 is external storage, such as an external hard drive, or insertable storage, such as an SD card. Storage 1724 may be persistent and/or volatile. In some embodiments, storage 1724 may take the form of a quantum computing storage device for storing data in the form of qubits. In embodiments where computer 1701 is required to have a large amount of storage (for example, where computer 1701 locally stores and manages a large database) then this storage may be provided by peripheral storage devices designed for storing very large amounts of data, such as a storage area network (SAN) that is shared by multiple, geographically distributed computers. IoT sensor set 1725 is made up of sensors that can be used in Internet of Things applications. For example, one sensor may be a thermometer and another sensor may be a motion detector.

NETWORK MODULE 1715 is the collection of computer software, hardware, and firmware that allows computer 1701 to communicate with other computers through WAN 1702. Network module 1715 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1715 are performed on the same physical hardware device. In other embodiments (for example, embodiments that utilize software-defined networking (SDN)), the control functions and the forwarding functions of network module 1715 are performed on physically separate devices, such that the control functions manage several different network hardware devices. Computer readable program instructions for performing the inventive methods can typically be downloaded to computer 1701 from an external computer or external storage device through a network adapter card or network interface included in network module 1715.

WAN 1702 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1703 is any computer system that is used and controlled by an end user (for example, a customer of an enterprise that operates computer 1701), and may take any of the forms discussed above in connection with computer 1701. EUD 1703 typically receives helpful and useful data from the operations of computer 1701. For example, in a hypothetical case where computer 1701 is designed to provide a recommendation to an end user, this recommendation would typically be communicated from network module 1715 of computer 1701 through WAN 1702 to EUD 1703. In this way, EUD 1703 can display, or otherwise present, the recommendation to an end user. In some embodiments, EUD 1703 may be a client device, such as thin client, heavy client, mainframe computer, desktop computer and so on.

REMOTE SERVER 1704 is any computer system that serves at least some data and/or functionality to computer 1701. Remote server 1704 may be controlled and used by the same entity that operates computer 1701. Remote server 1704 represents the machine(s) that collect and store helpful and useful data for use by other computers, such as computer 1701. For example, in a hypothetical case where computer 1701 is designed and programmed to provide a recommendation based on historical data, then this historical data may be provided to computer 1701 from remote database 1730 of remote server 1704.

PUBLIC CLOUD 1705 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1705 is performed by the computer hardware and/or software of cloud orchestration module 1741. The computing resources provided by public cloud 1705 are typically implemented by virtual computing environments that run on various computers making up the computers of host physical machine set 1742, which is the universe of physical computers in and/or available to public cloud 1705. The virtual computing environments (VCEs) typically take the form of virtual machines from virtual machine set 1743 and/or containers from container set 1744. It is understood that these VCEs may be stored as images and may be transferred among and between the various physical machine hosts, either as images or after instantiation of the VCE. Cloud orchestration module 1741 manages the transfer and storage of images, deploys new instantiations of VCEs and manages active instantiations of VCE deployments. Gateway 1740 is the collection of computer software, hardware, and firmware that allows public cloud 1705 to communicate through WAN 1702.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1706 is similar to public cloud 1705, except that the computing resources are only available for use by a single enterprise. While private cloud 1706 is depicted as being in communication with WAN 1702, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1705 and private cloud 1706 are both part of a larger hybrid cloud.

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a memory that stores computer executable components; and
a processor, operably coupled to the memory, that executes at least one of the computer executable components that:
generates a profiling prediction of a quantum environment based on a profiling matrix using a hybrid time series model, wherein the profiling prediction predicts resource consumption of the quantum environment for a portion of an execution in the quantum environment; and
allocates resources between classical components and quantum components of the quantum environment for the portion of the execution based on the profiling prediction.

2. The system of claim 1, wherein the at least one of the computer executable components further:
generates the profiling matrix based on execution data, wherein the profiling matrix comprises a set of parameters that quantifies resource consumption of the quantum environment.

3. The system of claim 1, wherein the at least one of the computer executable components further:
generates a time series of the profiling matrix for the execution in the quantum environment; and
trains the hybrid time series model to generate the profiling prediction based on the time series.

4. The system of claim 1, wherein generating the profiling prediction comprises:
generating the profiling matrix;
creating a configuration of resources of the quantum environment based on the profiling matrix;
defining one or more workloads of the execution; and
simulating the one or more workloads.

5. The system of claim 1, wherein the at least one of the computer executable components further:
receives a set of constraints comprising at least one of resource types, simulation length, or overhead constraints; and
generates, via the hybrid time series model, the profiling matrix based on the set of constraints.

6. The system of claim 2, wherein the at least one of the computer executable components further:
executes a quantum experiment in the quantum environment with an allocation of resources based on the profiling matrix to generate the execution data; and
trains the hybrid time series model on historical data of the set of parameters, the profiling matrix, and a corresponding ground truth, wherein the corresponding ground truth comprises the execution data.

7. The system of claim 3, wherein generating the time series comprises:
iteratively generating the profiling matrix throughout the execution in the quantum environment based on the profiling prediction of one or more portions of the execution.

8. A computer-implemented method, comprising:
generating, by a system operatively coupled to a processor, a profiling prediction of a quantum environment based on a profiling matrix using a hybrid time series model, wherein the profiling prediction predicts resource consumption of the quantum environment for a portion of an execution in the quantum environment using a hybrid time series model; and
allocating, by the system, resources between classical components and quantum components of the quantum environment for the portion of the execution based on the profiling prediction.

9. The computer-implemented method of claim 8, further comprising:
generating, by the system, the profiling matrix based on execution data, wherein the profiling matrix comprises a set of parameters that quantifies resource consumption of the quantum environment.

10. The computer-implemented method of claim 8, further comprising:
generating, by the system, a time series of the profiling matrix for the execution in the quantum environment; and
training, by the system, the hybrid time series model to generate the profiling prediction based on the time series.

11. The computer-implemented method of claim 8, wherein generating the profiling prediction comprises:
generating the profiling matrix;
creating a configuration of resources of the quantum environment based on the profiling matrix;
defining one or more workloads of the execution; and
simulating the one or more workloads.

12. The computer-implemented method of claim 8, further comprising:
receiving, by the system, a set of constraints comprising at least one of resource types, simulation length, or overhead constraints; and
generating, by the system and via the hybrid time series model, the profiling matrix based on the set of constraints.

13. The computer-implemented method of claim 9, further comprising:
executing, by the system, a quantum experiment in the quantum environment with an allocation of resources based on the profiling matrix to generate the execution data; and
training, by the system, the hybrid time series model on historical data of the set of parameters, the profiling matrix, and a corresponding ground truth, wherein the corresponding ground truth comprises the execution data.

14. The computer-implemented method of claim 9, wherein generating the time series comprises:
iteratively generating the profiling matrix throughout the execution in the quantum environment based on the profiling prediction of one or more portions of the execution.

15. A computer program product facilitating profiling prediction of quantum environments, the computer program product comprising a computer readable storage medium having program instructions embodied therewith, the program instructions executable by a processor to cause the processor to:
generate, by the processor, a profiling prediction of a quantum environment based on a profiling matrix using a hybrid time series model, wherein the profiling prediction predicts resource consumption of the quantum environment for a portion of an execution in the quantum environment using a hybrid time series model; and
allocate, by the processor, resources between classical components and quantum components of the quantum environment for the portion of the execution based on the profiling prediction.

16. The computer program product of claim 15, wherein the program instructions executable by the processor further to cause the processor to:
generate, by the processor, the profiling matrix based on execution data, wherein the profiling matrix comprises a set of parameters that quantifies resource consumption of the quantum environment.

17. The computer program product of claim 15, wherein the program instructions executable by the processor further to cause the processor to:
generate, by the processor, a time series of the profiling matrix for the execution in the quantum environment; and
train, by the processor, the hybrid time series model to generate the profiling prediction based on the time series.

18. The computer program product of claim 15, wherein the program instructions executable by the processor further to cause the processor to:
receive, by the processor, a set of constraints comprising at least one of resource types, simulation length, or overhead constraints.

19. The computer program product of claim 16, wherein the program instructions executable by the processor further to cause the processor to:
execute, by the processor, a quantum experiment in the quantum environment with an allocation of resources based on the profiling matrix to generate the execution data; and
train, by the processor, the hybrid time series model on historical data of the set of parameters, the profiling matrix, and a corresponding ground truth, wherein the corresponding ground truth comprises the execution data.

20. The computer program product of claim 16, wherein the program instructions executable by the processor further to cause the processor to:
iteratively generate, by the processor, the profiling matrix throughout the execution in the quantum environment based on the profiling prediction of one or more portions of the execution.
